(19) United States
(12) Patent Application Publication
(10) Pub. No.: US 2012/0064229 A1
(43) Pub. Date: Mar. 15, 2012

(54) POLYMER ACIDS AS BINDER AND PH REDUCING AGENT FOR AQUEOUS LITHIUM-ION CELLS

(75) Inventors: Milburn Ebenezer Jacob Muthu, Breinigsville, PA (US); Monira Mamari, Allentown, PA (US); Chester Crane, Bangor, PA (US)

(73) Assignee: INTERNATIONAL BATTERY, INC., Allentown, PA (US)

(21) Appl. No.: 13/104,176

(22) Filed: May 10, 2011

(51) Int. Cl. B05D 5/12; H01B 1/24; H01M 4/525

(52) U.S. Cl. 427/77; 252/182.1; 252/508

(57) ABSTRACT

A positive electrode for an electrochemical cell. The positive electrode includes a current collector that is coated with a slurry comprising a positive active material, a water-soluble polymer which acts as a binder and pH adjuster, a conductive additive and water. The positive active slurry was then coated on to the current collector and dried.

### FIELD OF INVENTION

The present invention relates to aqueous electrode slurries for lithium ion cells.

### BACKGROUND

The aqueous based process of manufacturing positive active material electrodes for Li-ion cells using LiCoO₂, LiNiCoAlO₂, LiNiCoMnO₂, lithium transition metal oxides containing nickel and cobalt compounds and combinations thereof are practically impossible because the pH of the slurry is too high. A positive electrode slurry made using a conventional aqueous based process typically yields a high pH of over 11.8, which adversely affects the surface property of the oxide based cathode material. In addition to the surface property modification, the high pH also adversely affects the dispersion of the active material, adhesion to the current collector and the micro structure of the aluminum current collector.

It would be beneficial to develop an electrode slurry having a sufficiently low pH that does not adversely affect the positive active material during the manufacturing of a positive electrode.

### SUMMARY

In one respect, the invention comprises a slurry for a positive electrode for an electrochemical cell, the slurry comprising: a positive active material consisting essentially of a lithium transition metal oxide, a water-soluble polymeric binder, and water, wherein the slurry has a pH in the range of 7 to 11 and would have a pH of at least 11.8 in the absence of the water-soluble polymeric binder.

In another respect, the invention comprises a method of forming an electrochemical cell electrode comprising the steps of:

a) forming a slurry comprising a positive active material, a water-soluble polymeric binder, and water, the slurry having a pH equal to or greater than 11.8 in the absence of the water-soluble polymeric binder;

b) providing a sufficient amount of the water-soluble binder in the slurry to reduce the pH of the slurry to between 7 and 11;

c) coating at least a portion of a current collector with the slurry; and

d) drying the slurry onto the current collector.

### BRIEF DESCRIPTION OF THE DRAWINGS

The foregoing summary, as well as the following detailed description of the invention, will be better understood when read in conjunction with the appended drawing. For the purpose of illustrating the invention, there are shown in the drawing certain embodiments of the present invention. It should be understood, however, that the invention is not limited to the precise arrangements and instrumentalities shown. In the drawings:

FIG. 1 is a schematic view of a cell formed in a jellyroll configuration according to an exemplary embodiment of the present invention;

FIG. 1A is a schematic view of the cell of FIG. 1 with the electrolyte;

FIG. 2 is a cross-sectional representation of a prismatic electrochemical cell according to an exemplary embodiment of the present invention;

FIG. 3 is a schematic representation of a positive electrode, a separator and a negative electrode bi-cell configuration of the exemplary embodiment illustrated in FIG. 1;

FIG. 4 is a flowchart illustrating exemplary steps to form an electrode according to an exemplary embodiment of the present invention;

FIG. 5 is a graph illustrating a charge/discharge curve of potential vs. time for an exemplary lithium metal half-cell manufactured with a positive electrode according to the present invention; and

FIG. 6 is a graph illustrating a cycles vs. specific capacity (mAh/g) for an exemplary lithium metal half-cell manufactured with a positive electrode according to the present invention.

### DETAILED DESCRIPTION OF THE PREFERRED EMBODIMENTS

In describing the embodiments of the invention illustrated in the drawings, specific terminology will be used for the sake of clarity. However, the invention is not intended to be limited to the specific terms so selected, it being understood that each specific term includes all technical equivalents operating in similar manner to accomplish similar purpose. It is understood that the drawings are not drawn exactly to scale. In the drawings, similar reference numbers are used for designating similar elements throughout the several figures.

The following describes particular embodiments of the present invention. It should be understood, however, that the invention is not limited to the embodiments detailed herein. The invention pertains to the manufacture of electrodes used in Li-ion cells. Electrodes manufactured according to the present invention include a current collector that is coated with an electrode mix slurry that is coated onto the current collector and then dried.

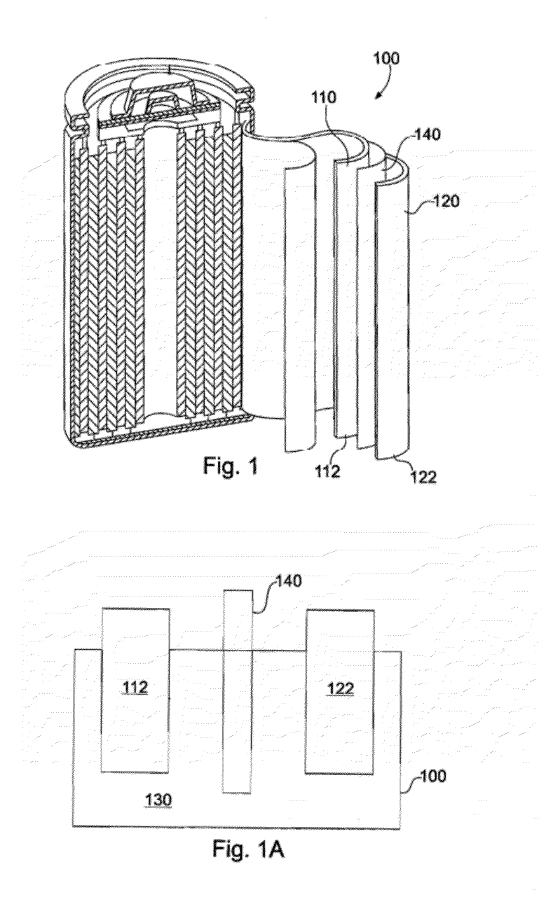

Referring to FIGS. 1 and 1A, a rechargeable lithium ion cell 100 according to an exemplary embodiment of the present invention includes a positive electrode 112 formed from a positive electrode mix 110 that is applied to an aluminum current collector 111, a negative electrode 122 formed from a negative electrode mix 120 that is applied to a copper current collector 121, and an electrolyte 130. A separator 140 separates positive electrode 112 from negative electrode 122. While FIG. 1 illustrates cell 100 formed in a “jellyroll” configuration, those skilled in the art will recognize that other formations, such as, for example, a prismatic configuration, which is illustrated in FIG. 2, may also be used within the teaching of the present invention.

In an exemplary embodiment, positive electrode mix 110 consists essentially of a positive active material, a water-soluble polymeric binder, and, optionally, a conductive additive. All of the materials are mixed together in a water medium to make a slurry.

In an exemplary embodiment, the positive active material is selected from the group consisting of LiFePO₄, LiNiCoAlO₂, LiMn₂O₄, LiCoO₂, LiNiCoMnO₂, lithium transition metal oxides containing nickel and cobalt compounds, LiNi_{y}CoₓM_{z}O, where M=Mn, Al, Sn, In, Ga or Ti and 0.15<x<0.5, 0.5<y<0.8 and 0<z<0.15, Li[Li_{(1-2y)/3}/Ni_{y}Mn_{(2-y)/3}]O₂, Li[Li_{(1-y)/3}CO_{y}Mn_{(2-2y)/3}]O₂ and Li[Ni_{y}Co_{1-2y}Mn_{y}]O₂ where x=(2−y)/3 and 0<y<0.5, LiNiCoO₂.MnO₂, lithium rich compounds Li_{1+y}(Ni_{1/3}Co_{1/3}Mn_{1/3})_{1-y}O₂, where x=0-0.33, y=(x/(2+x)) and xLi₂MnO₃(1−x)Li(NiCoMn)O₂ and Li_{(1+y)}(Ni_{0.5}CO_{0.2}Mn_{0.3})_{1-y}O₂, where x=0−0.33, y=(x/(2+x)), and LiMPO₄, where M is one or more of the first row transition-metal cations selected from the group consisting of V, Cr, Mn, Fe, Co, Ni, and combinations thereof.

In accordance with the present invention, the water-soluble polymeric binder functions as both a binder and as a pH reducing agent. Accordingly, it is important that the water-soluble polymeric binder provide a sufficient reduction in the pH of the slurry when provided in a proportion that will exhibit the desired binding characteristics, so as to provide a robust coating on positive electrode 112. It has been discovered that certain carboxylic acid-containing polymers are well-suited for this application. Examples of suitable carboxylic acid-containing polymers include polylactic acid (PLA), polyacrylic acid (PAA), polysuccinic acid, poly maleic acid and anhydride, poly furoic (pyromucic acid), poly fumaric acid, poly sorbic acid, poly linoleic acid, poly linolenic acid, poly glutamic acid, poly methacrylic acid, poly licanic acid, poly glycolic acid, poly aspartic acid, poly amic acid, poly formic acid, poly acetic acid, poly propoionic acid, poly butyric acid, poly sebacic acid, and copolymers thereof.

In an exemplary embodiment, the optional conductive additive may be carbon black, actylene black, or graphite.

The positive electrode mix 110 prepared by mixing between about 10 and about 90 percent (by weight) of positive active material, between about 0 and about 20 percent (by weight) of conductive additive, and between about 1 and about 10 percent (by weight) of the water-soluble polymeric binder. Water is added to form the slurry, which preferrably has a pH between about 7 and about 10. When LiMn₂O₄, LiFePO₄ or any other lithium transition metal oxide is used as the positive active material, with the natural pH is ranging from 7 to 11, a LiOH solution is preferably added to the water-soluble polymeric binder in an amount sufficient to neutralize the pH prior to adding the positive active material.

When the slurry reaches the desired pH, the slurry is coated onto a current collector, such as, for example, aluminum foil, carbon coated aluminum foil, or nickel foil, and dried to form a positive electrode.

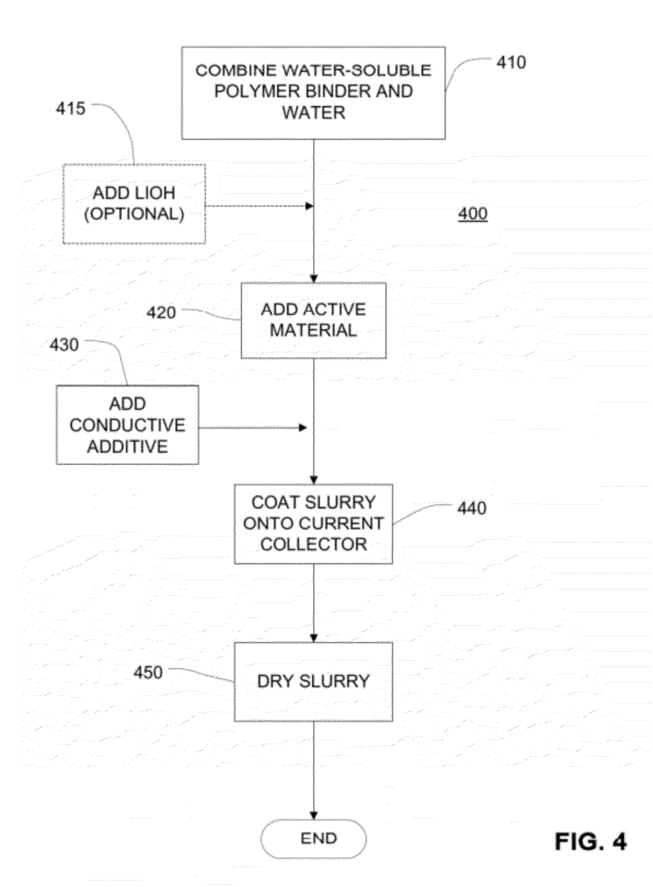

FIG. 4 shows an exemplary method of manufacturing a positive electrode. First, the water-soluble polymer binder and water are combined (step 410). Then, if needed, the LiOH solution is added (step 415) to the binder/water solution. Then, in step 420, the active material is added. Optionally, in step 430, the conductive additive may be added. In step 440, the slurry is applied to a positive current collector and in step 450, the slurry is dried, adhering to the current collector.

An electroactive negative electrode mix 120 includes a mix of negative active material, a water soluble binder, and, optionally, a conductive additive and/or a thickener. All of the materials are mixed together in a water medium to make a slurry.

In an exemplary embodiment, the negative active material is selected from the group consisting of graphite, hard carbon, silicon, silicon alloy, tin, tin alloy, and lithium titanate and any combination thereof. In an exemplary embodiment, the optional conductive additive material is selected from the group consisting of carbon black, actylene black and graphite. Exemplary binder material and the optional thickener are both disclosed above with respect to the positive electrode.

Negative active material mix 120 is prepared by mixing between about 10 and about 95 weight percent of active material, between about 0 and about 20 weight percent of conductive additive, and between about 1 and about 10 weight percent of binder polymer. Water is added to the mix to form a slurry. Between about 0 and about 10 weight percent of the thickener may be added to the slurry. The water soluble binder may optionally be used to make the negative electrode slurry without adding any thickening agent to control the viscosity.

The negative electrode slurry pH is between about 7 and about 10 and does not need polymeric acids to control the pH of the slurry. The slurry is coated on a copper current collector and dried to form a negative electrode.

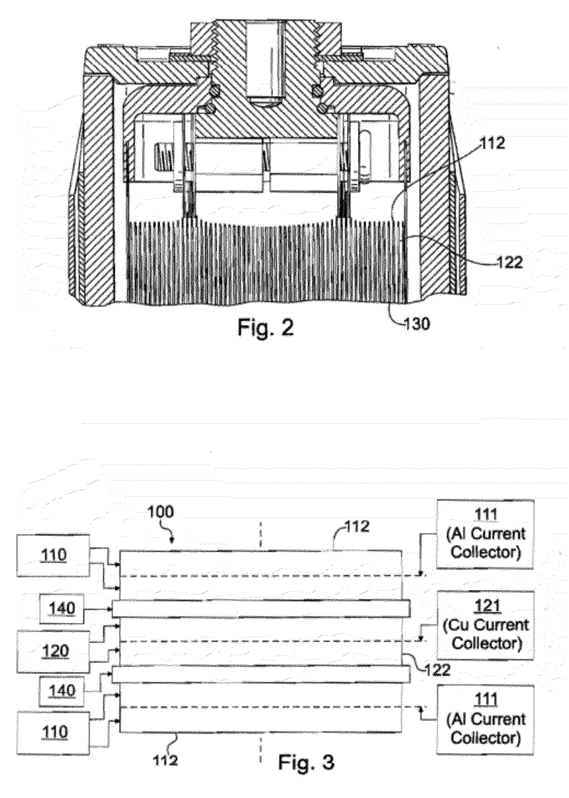

After the positive and the negative electrodes are formed, the electrodes are used to form a cell 100, schematically illustrated in FIG. 3. A positive electrode 112 and a negative electrode 122, manufactured according to the present invention, are separated by a porous separator 140, as is well known in the art. Cell 100 may be a cylindrical cell as shown in FIG. 1, or, alternatively, cell 100 may be a large format prismatic cell shown in FIG. 2.

### Example

The following example is provided for the purpose of illustrating a specific implementation of the invention and is not intended to limit the scope of the invention in any way. A positive electrode mix was prepared by mixing a powdered positive active material (90% by weight) consisting of LiNiCoAlO₂, manufactured by Toda Corporation, a water-soluble binder (6% by weight) consisting of poly acrylic acid, purchased from Aldrich Chemicals (35% solid and a molecular weight of 250,000), and a conductive additive (4% by weight) consisting of Super P®, manufactured by Timcal Graphite & Carbon. The positive electrode mix was mixed with a water solution for about 2 hours to form the slurry. After mixing thoroughly, the pH of the slurry was between 10 and 11. The slurry was then coated on a Nickel current collector to form the positive electrode. The positive electrode was then cut into an appropriate size and dried in a vacuum oven until the moisture was below about 1000 ppm and most preferably below about 200 ppm.

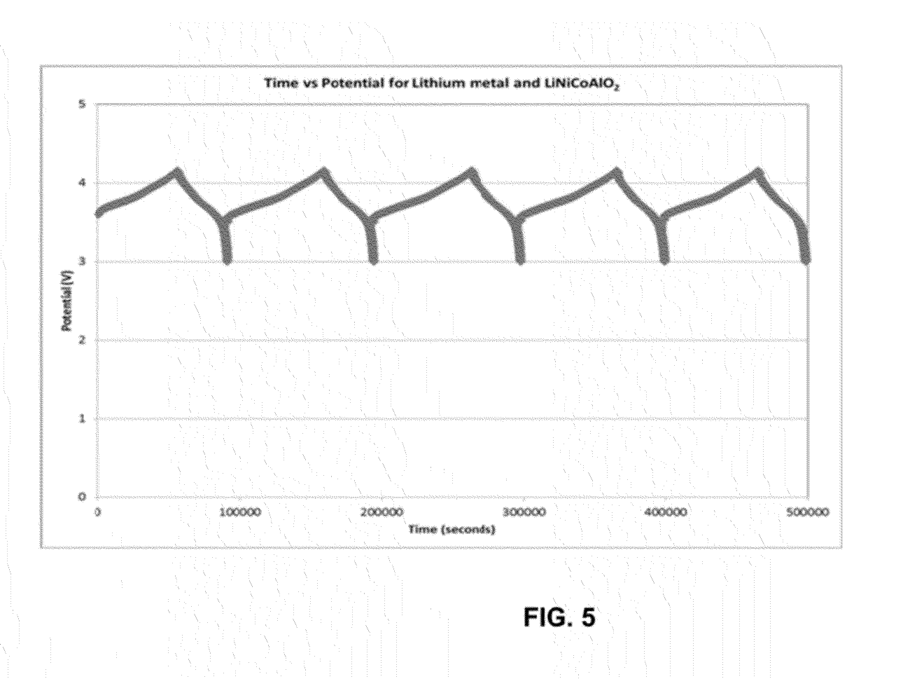

Lithium half cells using positive electrodes made in accordance with the above-described example were built for capacity evaluation. The cells were then filled with electrolyte. FIG. 5 illustrate exemplary charge/discharge curves for a LiNiCoAlO₂ electrode with polymeric acid binder and pH adjuster according to an exemplary embodiment of the present invention.

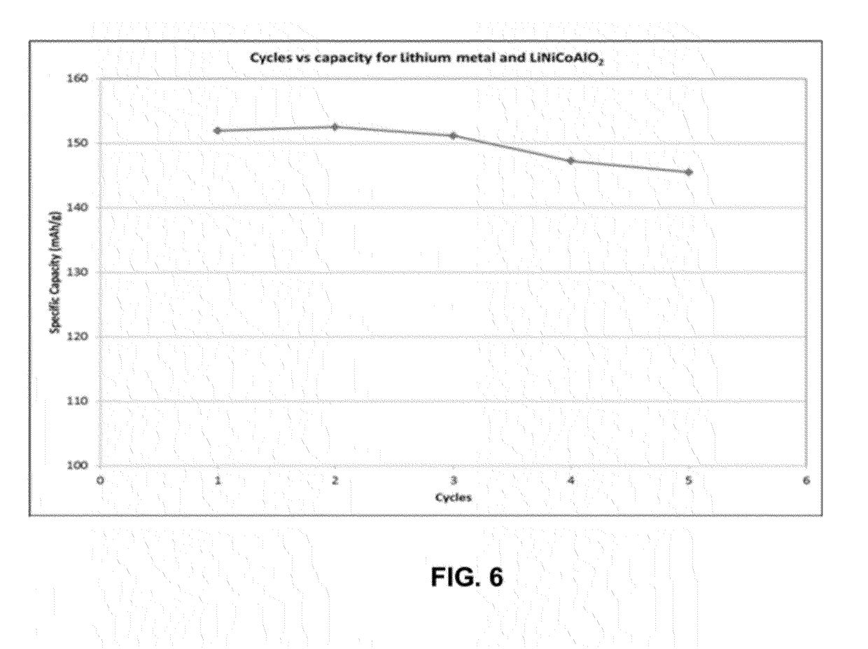

FIG. 5 is a graph illustrating a charge/discharge curve of potential vs. time for an exemplary lithium metal half-cell manufactured with a positive electrode according to the present invention and FIG. 6 is a graph illustrating cycles vs. specific capacity (mAh/g) for an exemplary lithium metal half-cell manufactured with a positive electrode according to the present invention. Based on the data collected in these graphs, the charge/discharge and specific capacity characteristics of this half-cell are well-within expected ranges.

While the principles of the invention have been described above in connection with preferred embodiments, it is to be clearly understood that this description is made only by way of example and not as a limitation of the scope of the invention.

1. A slurry for a positive electrode for an electrochemical cell, the slurry comprising:
a positive active material consisting essentially of a lithium transition metal oxide;
a water-soluble polymeric binder;
and water;
where in the slurry has a pH in the range of 7 to 11 and would have a pH of at least 11.8 in the absence of the water-soluble polymeric binder.

2. The slurry of claim 1, wherein the slurry has a pH in the range of 7 to 11.

3. The slurry of claim 1, wherein the water-soluble polymeric binder comprises a carboxylic acid.

4. The slurry of claim 3, wherein the carboxylic acid is selected from the group consisting of polylactic acid (PLA), polyacrylic acid, polysuccinic acid, poly maleic acid and anhydride, poly furoic (pyromucic acid), poly fumaric acid, poly sorbic acid, poly linoleic acid, poly linolenic acid, poly glutamic acid, poly methacrylic acid, poly licanic acid, poly glycolic acid, poly aspartic acid, poly amic acid, poly formic acid, poly acetic acid, poly propoionic acid, poly butyric acid, poly sebacic acid, and copolymers thereof.

5. The slurry of claim 1, wherein the slurry is formed in the absence of a thickener.

6. The slurry of claim 1, wherein the slurry further comprises a conductive additive.

7. The slurry of claim 1, wherein the slurry further comprises a lithium hydroxide solution.

8. The slurry of claim 1, wherein the positive active material is selected from the group consisting of LiFePO₄, LiNiCoAlO₂, LiMn₂O₄, LiCoO₂, LiNiCoMnO₂, lithium transition metal oxides containing nickel and cobalt compounds, LiNi_{y}CoₓM_{z}O, where M=Mn, Al, Sn, In, Ga or Ti and 0.15<x<0.5, 0.5<y<0.8 and 0<z<0.15, Li[Li_{(1-2y)/3}Ni_{y}Mn_{(2-y)/3}]O₂, Li[Li_{(1-y)/3}Co_{y}Mn_{(2-2y)/3}]O₂ and Li[Ni_{y}Co_{1-2y}Mn_{y}]O₂ where x=(2−y)/3 and 0<y<0.5, LiNiCoO₂.MnO₂, lithium rich compounds Li_{1+y}(Ni_{1/3}Co_{1/3}Mn_{1/3})_{1-y}O₂, where x=0-0.33, y=(x/(2+x)) and xLi₂MnO₃(1−x)Li(NiCoMn)O₂ and Li_{(1+y)}(Ni_{0.5}CO_{0.2}Mn_{0.3})_{1-y}O₂, where x=0-0.33, y=(x/(2+x)), and LiMPO₄, where M is one or more of the first row transition-metal cations selected from the group consisting of V, Cr, Mn, Fe, Co, Ni, and combinations thereof.

9. The slurry of claim 1, wherein the slurry comprises 10 to 90 percent positive active material by weight and 1 to 10 percent water-soluble polymeric binder by weight.

10. A method of forming a electrochemical cell electrode comprising the steps of:
a) forming a slurry comprising a positive active material, a water-soluble polymeric binder, and water, the slurry having a pH equal to or greater than 11.8 in the absence of the water-soluble polymeric binder;
b) providing a sufficient amount of the water-soluble binder in the slurry to reduce the pH of the slurry to between 7 and 11;
c) coating at least a portion of a current collector with the slurry; and
d) drying the slurry onto the current collector.

11. The method according to claim 10, wherein step a) further comprises forming a slurry comprising a positive active material, a water-soluble polymeric binder, a lithium hydroxide solution and water.

12. The method according to claim 11, wherein step a) further comprises combining the lithium hydroxide solution with the water-soluble binder and the water prior to adding the positive active material to the slurry.

13. The method according to claim 10, wherein step a) further comprises forming a slurry comprising a positive active material, a water-soluble polymeric binder, a lithium hydroxide solution and water, wherein the positive active material is selected from the group consisting of LiFePO₄, LiNiCoAlO₂, LiMn₂O₄, LiCoO₂, LiNiCoMnO₂, lithium transition metal oxides containing nickel and cobalt compounds, LiNi_{y}CoₓM_{z}O, where M=Mn, Al, Sn, In, Ga or Ti and 0.15<x<0.5, 0.5<y<0.8 and 0<z<0.15, Li[Li_{(1-y)/3}Ni_{y}Mn_{(2-y)/3}]O₂, Li[Li_{(1-y)/3}Co_{y}Mn_{(2-2y)/3}]O₂ and Li[Ni_{y}Co_{1-2y}Mn_{y}]O₂ where x=(2−y)/3 and 0<y<0.5, LiNiCoO₂.MnO₂, lithium rich compounds Li_{1+y}(Ni_{1/3}Co_{1/3}Mn_{1/3})_{1-y}O₂, where x=0-0.33, y=(x/(2+x)) and xLi₂MnO₃(1−x)Li(NiCoMn)O₂ and Li_{(1+y)}(Ni_{0.5}CO_{0.2}Mn_{0.3})_{1-y}O₂, where x=0-0.33, y=(x/(2+x)), and LiMPO₄, where M is one or more of the first row transition-metal cations selected from the group consisting of V, Cr, Mn, Fe, Co, Ni, and combinations thereof.

14. The method according to claim 10, wherein step a) further comprises forming a slurry comprising a positive active material, a water-soluble polymeric binder consisting of a carboxylic acid-containing polymer, and water.

15. The method according to claim 10, wherein step a) further comprises forming a slurry comprising a positive active material, a water-soluble polymeric binder, and water, wherein the water-soluble polymeric binder is selected from the group consisting of polylactic acid (PLA), polyacrylic acid, polysuccinic acid, poly maleic acid and anhydride, poly furoic (pyromucic acid), poly fumaric acid, poly sorbic acid, poly linoleic acid, poly linolenic acid, poly glutamic acid, poly methacrylic acid, poly licanic acid, poly glycolic acid, poly aspartic acid, poly amic acid, poly formic acid, poly acetic acid, poly propoionic acid, poly butyric acid, poly sebacic acid, and copolymers thereof.

16. The method according to claim 10, wherein step a) further comprises forming a slurry comprising a positive active material, a water-soluble polymeric binder consisting of polyacrylic acid, and water.

17. The method according to claim 10, wherein the slurry is formed in the absence of a thickener.

18. The method according to claim 10, wherein step a) further comprises forming a slurry consisting essentially of a positive active material, a water-soluble polymeric binder, a lithium hydroxide solution, a conductive additive and water.
